(19) United States
(12) Patent Application Publication
(10) Pub. No.: US 2026/0251181 A1
(43) Pub. Date: Aug. 27, 2026

(54) STATIC SEALING DEVICE FOR A WHEEL HUB ASSEMBLY OF A VEHICLE AND ASSOCIATED HUB BEARING UNIT

(71) Applicant: AKTIEBOLAGET SKF, GOTEBORG (SE)

(72) Inventors: Riccardo NARDICCHIA, Torino (IT); Ivan MAURO, Bricherasio (IT); Luca TEDESCHINI, Torino (IT)

(21) Appl. No.: 19/543,992

(22) Filed: Feb. 19, 2026

(30) Foreign Application Priority Data
Feb. 27, 2025 (IT) 102025000004074

(51) Int. Cl. F16C 33/76; F16C 43/04; F16C 19/08

(52) U.S. Cl. CPC F16C 33/768; F16C 43/045; F16C 19/08; F16C 2326/02

(57) ABSTRACT

A static sealing device for a wheel hub assembly of a vehicle,. The wheel hub assembly includes a rolling bearing and a constant velocity joint, the rolling bearing having a radially outer ring, a radially inner ring, and an insert ring mounted on the radially inner ring and including an annular shoulder surface. The static sealing device includes a foam annular gasket formed directly in place on the annular shoulder surface such that it is integrally fixed to the annular shoulder surface, and a tubular element straddling the insert ring and the constant velocity joint and having a first end in direct contact with the foam annular gasket. Also a rolling bearing including the static sealing device.

### CROSS-REFERENCE

This application claims priority to Italian patent application no. 102025000004074 filed on February 27, 2025, the contents of which are fully incorporated herein by reference.

### TECHNOLOGICAL FIELD

The present disclosure relates to a static sealing device for a wheel hub assembly of a vehicle, as well as to an associated hub bearing unit and to the associated wheel hub assembly.

### BACKGROUND

Conventional vehicle wheel hub assemblies generally include a rolling bearing configured to form a hub bearing unit, a constant velocity joint angularly coupled to the hub bearing unit via a grooved or frontally toothed coupling; and a sealing device. The sealing device may include a static seal arranged straddling the hub bearing unit and the constant velocity joint so as to protect the coupling, and a sealing shield, which may also be provided with a speed sensor or encoder, coupled to the hub bearing unit, namely in particular, coupled to an insert ring or “snap ring” that forms part of the hub bearing unit. The static seal may be defined, in its simplest form, by a sleeve element which cooperates with the constant velocity joint and may be integrally formed as one piece with the sealing shield.

However, such a configuration is not always the optimal configuration, in particular where the available axial space of the sealing device may be relatively limited and, even more so, when the assembly of the wheel hub assembly must be performed with special care in order to prevent or avoid any binding of the coupling. In fact, in some known solutions of the wheel hub assemblies described above, also in order to allow any inspection of the wheel hub assembly during assembly or, at least, highlight any assembly problems, the sleeve element is made separate from the sealing shield and may be pre-assembled either together with the constant velocity joint or together with the hub bearing unit, but, in both cases correct positioning thereof at the end of assembly must always be ensured. For this purpose, US 5,725,316 discloses a solution in which a sleeve element snap-engages inside an annular groove of an inner ring of a rolling bearing, where the inner ring is entirely comparable to the insert ring or “snap ring” forming part of a hub bearing unit. In other words US 5,725,316 describes and teaches how to axially fix a sleeve element to the insert ring or “snap ring” of the hub bearing unit, but does not say anything about how to protect in a fluid-tight manner the insert ring or “snap ring”, where this forms part of a hub bearing unit angularly coupled to a constant velocity joint, or how to protect the coupling itself between the wheel hub unit and the constant velocity joint.

### SUMMARY

An aspect of the present disclosure is to provide a static sealing device for a wheel hub assembly of a vehicle and an associated hub bearing unit or wheel bearing which do not have the abovementioned drawbacks and which, in particular, allow easy assembly, even in the presence of misalignments, and substantially fluid-tight protection of the toothed coupling between the inner ring of the rolling bearing constituting, or forming part of, the hub bearing unit and the constant velocity joint.

It is also an aspect of the disclosure to provide a wheel hub assembly equipped overall with such a static sealing device.

According to the present disclosure, a static sealing device for a vehicle wheel hub assembly, as well as an associated hub bearing unit or wheel bearing, as well as the associated wheel hub assembly, having the characteristic features described herein are provided.

### BRIEF DESCRIPTION OF THE DRAWINGS

The disclosure will now be described with reference to the accompanying drawings which illustrate a number of non-limiting examples of an embodiment thereof, in which:

FIG. 1 is a schematic sectional view a radial portion of a vehicle wheel hub assembly comprising a hub bearing unit or wheel bearing equipped with a static sealing device according to an embodiment of the present disclosure.

FIG. 2 is a schematic sectional view on a larger scale that FIG. 1 a radially sectioned detail of a first embodiment of a hub bearing unit or wheel bearing realized in accordance with the disclosure and provided with a static sealing device according to the disclosure.

FIG. 3 is a schematic sectional view of a second embodiment of a hub bearing unit or wheel bearing realized in accordance with the disclosure and provided with a static sealing device according to the disclosure.

FIG. 4 is a schematic sectional view of a third embodiment of a hub bearing unit or wheel bearing realized in accordance with the disclosure and provided with a static sealing device according to the disclosure.

### DETAILED DESCRIPTION

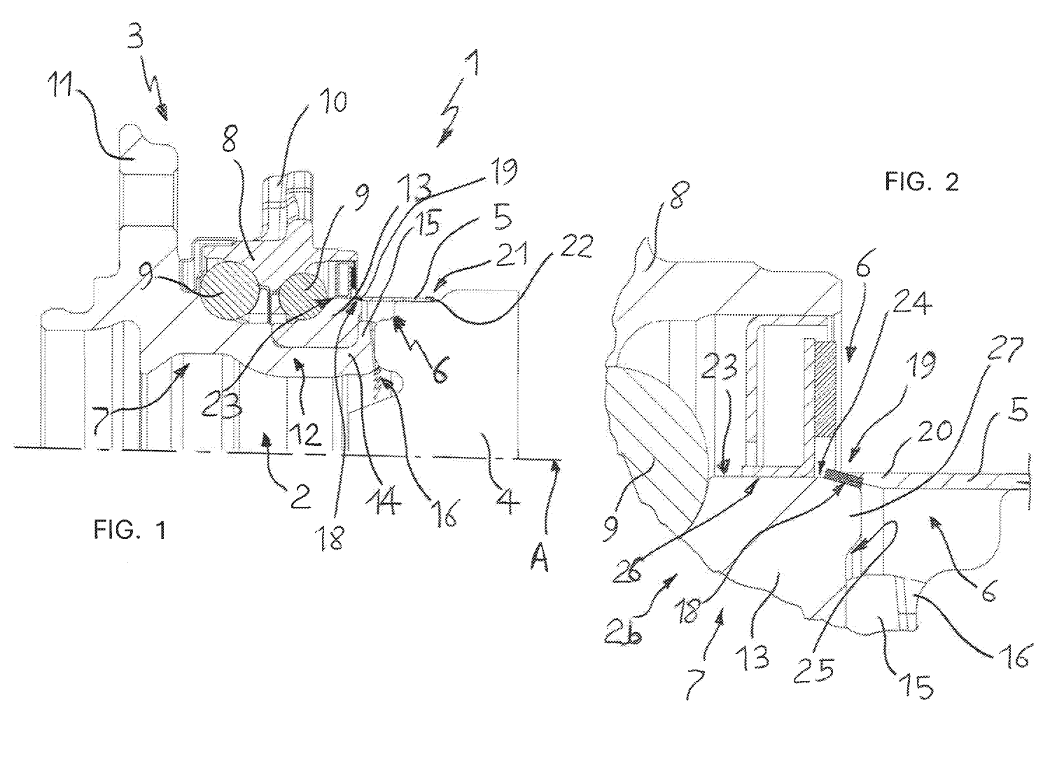

With reference to FIG. 1, reference numeral 1 denotes overall a vehicle wheel hub assembly comprising a rolling bearing 2 constituting, or forming part of, a hub bearing unit 3, and a constant velocity joint 4, of a known type and only partially shown for simpler illustration.

With reference also to FIGS. 2 to 4, the vehicle wheel hub assembly 1 also comprises a static sealing device 6 comprising a tubular element or sleeve 5 mounted for use such that is straddles the rolling bearing 2 and the constant velocity joint 4.

In particular, the rolling bearing 2 comprises a radially inner ring 7, a radially outer ring 8 and a plurality of rolling elements 9, in the example balls, interposed between the outer ring 8 and the inner ring 7 so as to make them relatively rotatable with a small amount of friction.

In the non-limiting example shown, the outer ring 8 is provided integrally as one piece with a radially outer flange 10 configured to be integrally fixed, during use, to a vehicle suspension system, known and not shown for simpler illustration, and the inner ring 7 is also provided with integrally as one piece with a radially outer flange 11 arranged axially facing and opposite the flange 10 and configured to receive, during use, a vehicle wheel (not shown).

Therefore, the rolling bearing 2 is of the so-called “double flanged” type and, together with the flanges 10 and 11, forms the hub bearing unit 3 of the wheel hub assembly 1.

The inner ring 7 comprises in turn a tubular spindle-shaped portion 12 and an insert ring 13 axially keyed so as to be locked onto a first end 14 of the spindle-shaped portion 12, opposite to the flange 11, by means of a terminal edge 15 of the end 14 upturned by means of plastic deformation against the insert ring 13. The rolling elements 9 are grouped together in two rows (of balls), a first row of which engages the spindle portion 12 and a second row of which engages the insert ring 13.

The first end 14 of the tubular spindle-shaped portion 12 of the inner ring 7 includes an angular coupling 16, in this case of the toothed type with front teeth, configured to receive in engagement, during use, the constant velocity joint 4 in a known manner. Of course, the angular coupling 16 could also be a grooved coupling instead of the front-tooth type or SFS (side face spline) type as shown.

The static sealing device 6 according to the disclosure comprises, in addition to the already mentioned sleeve or tubular element 5, an annular shoulder surface 18 formed on the insert ring 13 on the side where the tubular element 5 is located and, therefore, on the opposite side to the flange 11, and a foam annular gasket 19, which has been formed directly in place on the annular shoulder surface 18, so that it is integrally fixed to the annular shoulder surface 18 and configured to cooperate in a fluid-tight manner with one end 20 of the sleeve or tubular element 5 directed towards the rolling bearing 2 and, in this case, towards the insert ring 13.

The sleeve or tubular element 5 also includes, at a second end 21 thereof opposite to the end 20, an annular static sealing gasket which is made of conventional elastomer and which engages in a fluid-tight manner, during use, radially on the outside of the constant velocity joint 4.

According to one aspect of the disclosure, the foam annular gasket 19 must have a radial thickness of between 0.5 and 5 mm and an axial extension or width of between 3 and 10 mm. Moreover, the foam gasket 19 must have, on the basis of experimental tests carried out by technical experts of the applicant, a compressibility, understand as being a percentage value of possible elastic variation of its main dimensions (radial thickness and axial dimension or width), of between 10% and 60%.

The foam annular gasket 19 comprises an elastic synthetic foam material, preferably of the closed-cell type. Particularly suitable materials were selected following experimental tests and include a polyurethane foam or a silicone foam, preferably of the bicomponent type that is curable at room temperature. If necessary IR or UV curing is also possible in addition to bicomponent curing.

The static foam annular gasket 19 is formed in situ, i.e. directly on the surface 19, using FIPFG (Formed-In-Place-Foam-Gasket) technology, which is a known technology used for other purposes and which involves the application of a liquid sealant, which expands into a mixed or closed cell foam which chemically polymerizes. In a few minutes, at room temperature, the soft foam gasket 19 is formed without any joints. Differently from conventional vulcanized elastomer gaskets, in fact, FIPFG gaskets do not have joints after polymerization occurs, thus preventing the penetration of any moisture.

In the present application according to the disclosure, a soft foam gasket 19 made using FIPFG technology has proved to be suitable for adaptation to any arrangement of the components to be joined together in a fluid-tight manner (in this case the sleeve or tubular element 5 and the insert ring 13), owing to the fact that, if made in compliance with the aforementioned dimensional and compressibility parameters, it compensates for the dimensional tolerances and any misalignment and ensures a high degree of impermeability against moisture, water spray, dust and other environmental agents. The joining points of the gasket are practically invisible, ensuring a reliable and long-lasting seal.

On the basis of that described hitherto it is clear that the disclosure also relates to a rolling bearing, in this case the rolling bearing 2 configured to constitute, or form part of, a hub bearing unit 3, otherwise of the conventional type, in which the insert ring 13 has a radially outer side surface 23 (see in particular FIGS. 2-4) comprising an annular shoulder surface 18 situated on the same side as the end 14 and having a foam annular gasket 19 which has been formed directly in place (in situ) on the annular shoulder surface 18 and which is integrally fixed to the annular shoulder surface 18 as a result of the polymerization reaction with which the gasket 18 is obtained in situ after being deposited on the surface 18 as a bead of fluid sealant, preferably of the bicomponent type, configured to polymerize at room temperature, where necessary, with the additional or alternative application of UV or IR radiation.

According to the disclosure, the annular shoulder surface 18 is configured to cooperate during use, with the interposition of the foam annular gasket 19, with the tubular element 5 arranged during use straddling the insert ring 13 and the constant velocity joint 4 so as to form together with the foam gasket 19 and the shoulder surface 18 the static sealing device according to the disclosure, providing protection for the angular coupling 16.

As shown in FIGS. 2 to 4, different embodiments of the shoulder surface 18 and the foam gasket 19 are possible, provided that the foam annular gasket 19, arranged radially on the outside of the surface 18, has specific, specially selected, dimensional parameters, namely, of a radial thickness of between 0.5 and 5 mm and a predefined axial width such that the ratio of the radial thickness to the axial width of the foam annular gasket 19 is between 0.15 and 0.5. Moreover, the synthetic foam material from which the foam gasket 19 is made must be such that the foam gasket 19 overall has a compressibility, as defined above, of between 10% and 60%.

The rolling bearing 2 according to the disclosure therefore includes a foam annular gasket 19 which is made of foam material, preferably of the closed-cell type, chosen from the group consisting of a polyurethane form or a silicone foam, preferably both of the bicomponent type and curable at room temperature, and which is formed integrally as one piece with, and radially on the outside of, a shoulder surface 18 formed on the radially outer surface 23 of the insert ring 13 and configured to cooperate axially in abutment with the end 20 of the sleeve or tubular element 5, with the interposition of, or in frictional contact with, the expanded foam gasket 19.

With reference to FIG. 2, in a first embodiment 2b of the rolling bearing 2 according to the disclosure, the annular shoulder surface 18 is a conical section 24 of the radially outer side surface 23 of the insert ring 13.

The conical surface section 24 is arranged axially between a cylindrical section 26 of the radially outer side surface 23 immediately adjacent to the rolling elements 9 and a front face 25 of the insert ring 13, situated on the same side as the end 14, and therefore on the opposite side from the flange 11 and, according to a characteristic feature of the disclosure, having, in order to ensure a suitable fixing of the foam gasket 19, a roughness (e.g., Ra) of between 1.2 and 3.2 microns.

Preferably, in order to obtain sufficient axial space for the formation of the conical surface section 24 which forms the shoulder surface 18 of the disclosure, owing to the fact that it has a taper directed towards the terminal edge 15 and the conical surface 24 therefore converges towards an axis of symmetry A of the rolling bearing 2, the front face 25 is provided with an annular overhang 27, arranged radially on the outside of the terminal edge 15 turned upwards against the face 25 of the insert ring 13.

In this embodiment, the foam annular gasket 19 has the form of a frustoconical sleeve which has a substantially rectangular radial cross-section and which extends axially above the conical surface section 24 into the immediate vicinity of the cylindrical section 26 of the radially outer surface 23 of the insert ring 13.

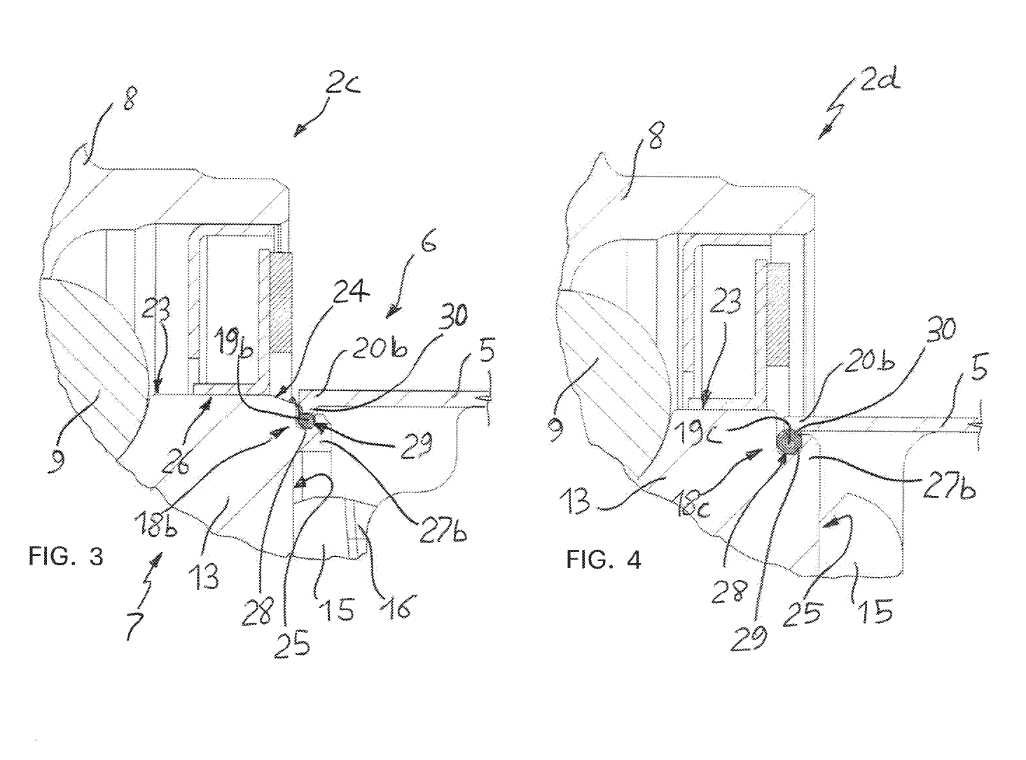

In the embodiment shown in FIG. 3, the rolling bearing 2c according to the disclosure includes a radially inner ring 7 comprising an insert ring 13 having, formed thereon, an annular shoulder surface 18b formed partly by a flat or curved bottom wall 28 and if required by at least one of the side walls of an annular groove 29 formed on the radially outer surface 23 of the insert ring 13, and partly by a conical section 24 of the radially outer side surface 23 of the insert ring 13, having a taper as in the embodiment of FIG. 2 and formed arranged between the annular groove 29, immediately adjacent thereto, and a cylindrical section 26 of the side surface 23 adjacent to the rolling elements 9.

In this embodiment, the rolling bearing 2c is provided with a foam gasket 19b which has a toroidal shape in the undeformed condition and which is housed inside the groove 29 and integrally fixed at least to the bottom wall 28. The static sealing device 6 is also completed by an annular tooth 30 (FIG. 3) which is continuous or formed in sections and made integrally as one piece radially on the whole of one end 20b of the tubular element or sleeve 5 and which snap-engages inside the groove 29, cooperating with interference with the foam gasket 19b.

Moreover, in this embodiment, the foam gasket 19b must have a compressibility such that during use, when engaged with interference by the tooth 30, it presses up against the conical surface section 24 forming part of the shoulder surface 18b, as schematically shown in FIG. 3.

The groove 29 is formed radially on the outside of an annular overhang 27b which projects axially from the face 25 of the insert ring 13.

With reference to FIG. 4, finally, this shows an embodiment 2d of the rolling bearing according to the disclosure, which is entirely similar to the embodiment 2c shown in FIG. 3, except for the fact that it does not have the conical surface section 24 and the overhang 27b. Details similar to or the same as those already described are indicated for the sake of simplicity by the same reference numbers.

In this embodiment, the foam gasket 19c, also in the form of a toroidal element, is housed inside the annular groove 29 where it is engaged by the tooth 30 and is fixed at least to the bottom wall 28 but has a compressibility less than that of the gasket 19b in FIG. 3. The annular groove 29 in this embodiment is formed directly radially on the outside of the side surface 23 of the insert ring 13, on the side where the front face 25 is located.

In both the embodiments shown in FIGS. 3 and 4, at least the bottom wall 28 of the groove 29 and the conical surface section 24, when present, have a roughness of between 1.2 and 3.2 microns, so as to allow the respective gasket 19b or 19c to operate correctly.

As a result of the present disclosure it is possible to obtain between the constant velocity joint and the rolling bearing constituting, or forming part of, the hub bearing unit 3 an efficient, compact and low-cost static seal which is unaffected by machining tolerances and any misalignment of the components.

Moreover, it also allows mechanical (snap-engaging or frictional) retention of the constant velocity joint 4 during the operations for assembly of the wheel hub assembly 1 before tightening (usually by means of a nut) of the joint between the constant velocity joint and the rolling bearing.

The disclosure provides a simple static sealing system which is able to adapt to different positions, tolerances and forms of the components which are coupled together.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved static sealing device for a wheel hub.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A static sealing device for a wheel hub assembly of a vehicle, the wheel hub assembly including a rolling bearing and a constant velocity joint, the rolling bearing including a radially outer ring, a radially inner ring, and an insert ring mounted on the radially inner ring, the insert ring including an annular shoulder surface, the static sealing device comprising:
a foam annular gasket formed directly in place on the annular shoulder surface such that it is integrally fixed to the annular shoulder surface, and
a tubular element straddling the insert ring and the constant velocity joint and having a first end in direct contact with the foam annular gasket.

2. The sealing device according to claim 1,
wherein the foam annular gasket has a radial thickness of between 0.5 and 5 mm and an axial extension of between 3 and 10 mm and a compressibility of between 10% and 60%.

3. The sealing device according to claim 1,
wherein the foam annular gasket comprises a closed-cell foam.

4. The sealing device according to claim 3,
wherein the foam annular gasket comprises a polyurethane foam or a silicone foam.

5. The sealing device according to claim 4,
wherein the polyurethane foam or the silicone foam is bicomponent material that is curable at room temperature.

6. The sealing device according to claim 1,
wherein the foam annular gasket comprises a formed-in-place-foam-gasket.

7. The sealing device according to claim 6,
wherein the annular shoulder is located at the bottom of a groove.

8. The sealing device according to claim 6,
wherein the annular shoulder is a conical surface.

9. The sealing device according to claim 1,
wherein the first end of the tubular element is pressed into the foam annular gasket.

10. A rolling bearing comprising
a radially outer ring,
a radially inner ring, and
a plurality of rolling elements interposed between the radially outer ring and the radially inner ring,
wherein the inner ring comprises a tubular portion and an insert ring axially keyed to a first end of the tubular portion,
wherein the first end of the tubular portion includes an angular coupling configured to couple to a constant velocity joint,
wherein the insert ring includes an annular shoulder surface with a foam annular gasket formed directly on the annular shoulder surface such that the foam annular gasket is integrally fixed to the annular shoulder surface, and
wherein the annular shoulder surface and the foam annular gasket are configure to cooperate with a tubular element straddling the insert ring and the constant velocity joint, the tubular element having an end in contact with the foam annular gasket.

11. The rolling bearing according to claim 10,
wherein the annular foam annular gasket has a radial thickness of between 0.5 and 5 mm, a predetermined axial width selected such that a ratio of the radial thickness to the axial width is between 0.15 and 0.5, and a compressibility of between 10% and 60%.

12. The rolling bearing according to claim 10,
wherein the annular foam gasket is made of a closed-cell foam, and
wherein the closed-cell foam is a polyurethane foam or a silicone foam.

13. The rolling bearing according to claim 12, wherein the closed-cell foam is a bicomponent type and is curable at room temperature.

14. The rolling bearing according to claim 10,
wherein the annular shoulder surface has a roughness of between 1.2 and 3.2 microns and comprises a bottom wall of an annular groove formed on a radially outer side surface of the insert ring, between a front face of the annular ring and the plurality of rolling elements.

15. The rolling bearing according to claim 14,
wherein the annular shoulder surface further comprises a conical section of the radially outer side surface of the insert ring arranged between the annular groove and the plurality of rolling elements.

16. The rolling bearing according to claim 10,
wherein the annular shoulder surface has a roughness of between 1.2 and 3.2 microns and comprises a conical section of the radially outer side surface of the insert ring arranged between a front face of the insert ring and the plurality of rolling elements.

17. The rolling bearing according to claim 10,
including the tubular element,
wherein the end of the tubular element is pressed into the foam annular gasket.

18. A method comprising:
providing a wheel hub assembly of a vehicle, the wheel hub assembly including a rolling bearing and a constant velocity joint, the rolling bearing including a radially outer ring, a radially inner ring, and an insert ring mounted on the radially inner ring, the insert ring including an annular shoulder surface, the static method comprising:
applying a liquid sealant to the annular shoulder surface, and
allowing the liquid sealant to expand into a mixed or closed-cell foam to form a formed-in-place-foam gasket when the liquid sealant cures.

19. The method according to claim 18, further including:
operatively connecting a constant velocity joint to the radially inner ring, and
placing a tubular element on the constant velocity joint such that a first portion of the tubular element surrounds the constant velocity joint, a second portion of the tubular element straddles a junction of the radially inner ring and the constant velocity joint and an end of the tubular element is pressed into the mixed or closed-cell foam.
